(19) United States
(12) Patent Application Publication
(10) Pub. No.: US 2016/0105387 A1
(43) Pub. Date: Apr. 14, 2016

(54) FILTERED MESSAGE STREAMS

(71) Applicant: Dean Kenneth JACKSON, Pittsburgh, PA (US)

(72) Inventor: Dean Kenneth JACKSON, Pittsburgh, PA (US)

(73) Assignee: Google Inc., Mountian View, CA (US)

(21) Appl. No.: 13/610,764

(22) Filed: Sep. 11, 2012

Related U.S. Application Data
(60) Provisional application No. 61/533,727, filed on Sep. 12, 2011.

(51) Int. Cl. H04L 12/58; H04L 29/08

(52) U.S. Cl. CPC H04L 51/32; H04L 67/18; H04L 51/12

(57) ABSTRACT

A system and method is disclosed for filtering messages in a social network. A message may be posted to a social network with a corresponding rank. On receiving the message and corresponding rank, the social network generates a perceived rank of the message for a receiving user and provides the message for display at the receiving user's message stream according to the perceived rank.

The present application claims priority benefit under 35 U.S.C. §119(e) from U.S. Provisional Application No. 61/533,727, filed Sep. 12, 2011, which is incorporated herein by reference in its entirety.

### BACKGROUND

The subject technology relates generally to posting and displaying messages in a social network. The amount of messages and other information pushed to a user by a social network increases linearly with the number of friends, associations, and interests (for example, things that the user likes) the user chooses to associate with in the social network. For those users who have a large number of contacts the amount of information pushed may become larger than can be reasonably absorbed by a user. Current browser applications that filter social media messages and other information do not work hand-in-hand with the social networks themselves and are limited by the relatively few filters that may be implemented at a receiving end.

### SUMMARY

The subject technology provides a computer-implemented method and system for filtering messages in a social network. According to one aspect, a computer-implemented method may include receiving, from a posting user, a message and a corresponding rank for the message, generating a perceived rank for the message based on the corresponding rank and a characteristic of a receiving user of the message, and providing the message for display at a message stream associated with the receiving user according to the perceived rank. Other aspects include corresponding systems, apparatus, and computer program products for implementation of the computer implemented method.

The previously described aspects and other aspects may include one or more of the following features. For example, the characteristic of the receiving user may include a geographical distance between a location associated with the receiving user and a location associated with the posting user. The characteristic of the receiving user may be a geographic region of the receiving user, wherein the perceived rank is higher when the receiving user is in a geographic region associated with the posting user, and lower if the receiving user is in another geographic region. The characteristic of the receiving user may include a social group assigned to the receiving user by the posting user. The perceived rank may be based on how the message is treated by a group of receiving users. The characteristic of the receiving user may include how other messages from the posting user have been treated by the receiving user. The characteristic of the receiving user may include a number of interactions with the message stream by the receiving user over a predetermined period of time. In this regard, the method may further comprise reducing the perceived rank when the number of interactions over the predetermined period of time is below a predetermined threshold, and increasing the perceived rank as the number of interactions with the message stream increases.

In another aspect, a machine-readable medium includes machine-executable instructions for performing a method for filtering messages in a social network. In this regard, the method may include facilitating the receipt of one or more messages for display in a message stream, a message including a corresponding message rank. For a respective message, the method may include determining a perceived rank for the message based on the corresponding message rank and geographical region of one or more receiving users of the message, filtering the one or more messages for display in the message stream to the one or more receiving users based on respective perceived ranks, and providing one or more of the filtered messages to the message stream for display according to the respective perceived ranks. Other aspects include corresponding systems, apparatus, and computer program products.

The previously described aspects and other aspects may include one or more of the following features. For example, determining the perceived rank may include adjusting the message rank according to a geographical distance between a stored location related to the message stream and a corresponding posting user. Determining the perceived rank may include increasing the perceived rank for receiving users associated with the same geographic region as a corresponding posting user, and lowering the perceived rank for receiving users associated with other geographic regions.

In a further aspect, a system includes a processor and a memory. In this regard, the memory may include instructions that, when executed, may cause the processor to facilitate receiving, from a posting user interface, a message and a message rank for the message, for a plurality of user contacts designated by the message, determine perceived ranks for the message based on the message rank and a characteristic of a respective user contact, and provide the message for display to one or more of the plurality of user contacts according to a perceived rank determined for the one or more of the plurality of user contacts. Other aspects include corresponding systems, apparatus, methods, and computer program products.

The previously described aspects and other aspects may include one or more of the following features. For example, the characteristic of the respective user contact may include one or more adjustments to the message rank received from the posting user interface. The characteristic of the respective user contact may include one or more interactions with other messages at the message stream of the respective user contact. In this regard, the instructions, when executed, may further cause the processor to reduce the perceived rank for the message when a number of the interactions over a predetermined period of time is below a predetermined threshold, and increase the perceived rank as the number of the interactions increases. Additionally or in the alternative, the perceived rank for the message may be based on the number of the interactions compared to a number of new user contacts added by the respective user contact in the predetermined period. The message may also be provided to be displayed at location of a user interface, or in a color, selected based on the perceived rank

The instructions, when executed, may further cause the processor to generate the characteristic of the respective user contact based on selections received from the posting user interface. In this regard, the characteristic of the respective user contact may include a geographical distance between a location associated with a posting user and a location associated with the respective user contact. Additionally, determining the perceived rank may include setting the perceived rank at a higher level for user contacts that are closer to the posting user than for user contacts that are farther away from the posting user.

The characteristic of the respective user contact may include a geographic region of the respective user contact. In this regard, determining the perceived rank may include setting the perceived rank at a higher level for user contacts associated with the same geographic region as the posting user, and a lower level for user contacts in other geographic regions. The instructions, when executed, may further cause the processor to, for the plurality of user contacts, determine the respective perceived ranks based on one or more metrics of a receiving user population, wherein the receiving user population includes the plurality of user contacts. In this regard, the one or more metrics may include an overall user response to the message. The instructions, when executed, may further cause the processor to automatically adjust a perceived rank for a first set of the plurality of user contacts based on filtering adjustments made by a second set of the plurality of user contacts.

The previously described aspects and other aspects may provide one or more advantages, including, but not limited to, providing a mechanism to limit or filter messages posted to a message stream to reduce the display of lesser important messages, to display only important messages, or to change the display of important messages (for example, the color, font, putting the message in a different part of the user interface, or the like) to distinguish them from lesser important messages. Moreover, the subject technology enables a user to attach a level of importance to a message posted to a message stream so that the message may be distinguished from other messages in the message stream.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

A detailed description will be made with reference to the accompanying drawings:

FIG. 1 is a diagram of an example system for displaying ranked messages.

FIG. 2 is a diagram of an example system for adjusting a message rank based on a receiving user population.

FIG. 3 is a diagram of an example system for automatically filtering a message based on one or more characteristics of a message stream.

FIG. 4 is a flowchart illustrating an example process for filtering messages in a social network.

FIG. 5 is a diagram of an example system for filtering and displaying messages in a social network.

FIG. 6 is a diagram illustrating an example machine or computer for filtering and displaying messages in a social network, including a processor and other internal components.

### DETAILED DESCRIPTION

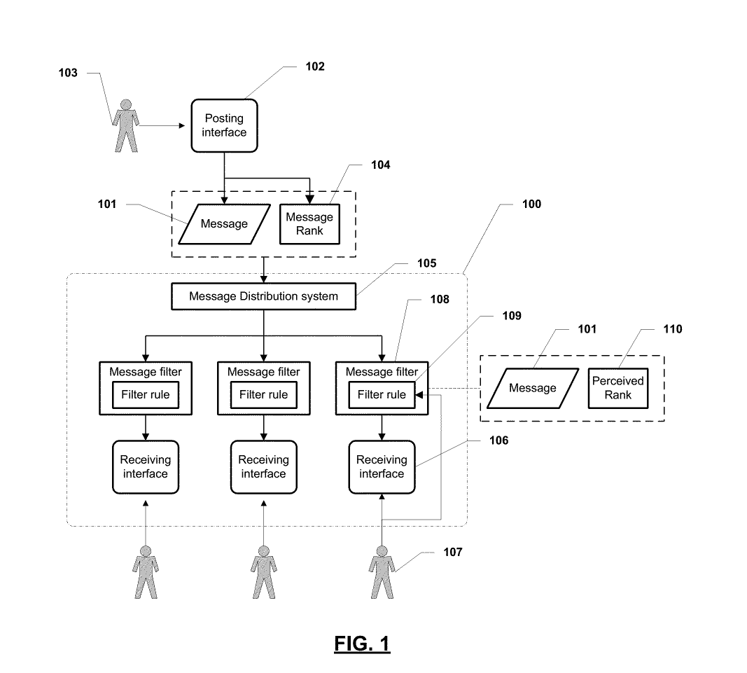

FIG. 1 is a diagram of an example system for displaying ranked messages according to one aspect of the subject technology. The subject technology provides a web-enabled system 100 that enables a user to assign a rank (for example, a level of importance) to a message 101 that is posted to a social network, and to filter received messages based on rankings assigned to the messages by other users. A posting user interface 102 may allow a posting user 103 to control how other users view message 101 by the selection and assigning of a message rank 104 to the message. Posting user 103 may, for example, be prompted by posting interface 102 to provide or select a message rank 104 for message 101 prior to it being published on the social network and pushed to other users (for example, to the posting user's contacts).

In some aspects, message rank 104 may be based on (for example, represented by) a number (for example, from one to five), a star system, a character representation (for example, “important”, “very important”), or the like. Message rank 104 may also be based on a text phrase representative of the type of message (for example, “resend”, “chat”, “talk”, “converse”, “announce”, or the like). Once ranked, message 101 and rank 104 may be routed through a message distribution system 105 (for example, a social network implemented by a network of servers, computers, databases, or the like). In one aspect, distribution system 105 may route message 101 to one or more users. In other aspects, distribution system 105 may store message 101 in a central location (for example, a database) to be made available for display at one or more receiving user interfaces 106.

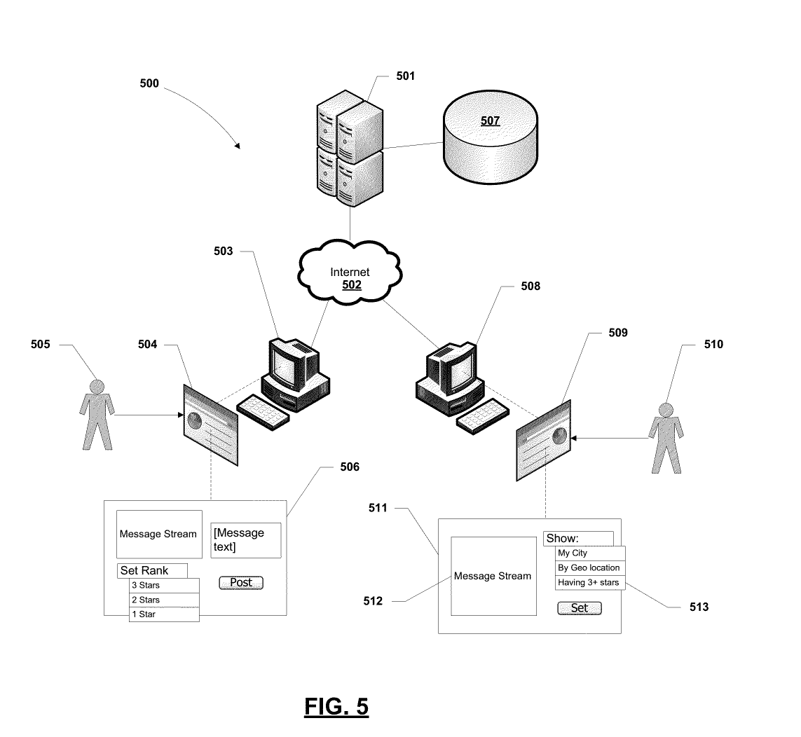

A receiving user interface 106 may include a message stream (for example, a message feed, activity stream, news feed, or the like) for the display of one or more messages 101 pushed to or viewable by a receiving user 107 (see, for example, FIG. 5). Receiving interface 106 may further be associated with one or more message filters 108 for filtering messages 101 received at receiving interface 106. In one aspect, a receiving user 107 may make selections at receiving user interface 106 to create or modify one or more filter rules 109. One or more filter rules 109 may configure filter 108 to filter messages 101 based on the selections of receiving user 107 and the rank assigned to each message.

A filter rule 109 may filter the message streams based on the ranking itself, or a range of rankings, for example, “show all message streams having a rank of four or five,” or “four or above.” One or more filter rules 109 may also be stored (for example, in a database) for use by filter 108 so that filter 108 may automatically filter messages 101 that are pushed to receiving user 107. Each filter rule 109 may be configured to filter messages provided for display at a receiving interface 106, and thus each user interface 106 may be configured to display a different set of messages 101, even if receiving a similar set of messages.

In some aspects, a filter rule 109 may modify rank 104 to create a perceived rank 110 for each message 101 provided for display at a receiving user's message stream. Perceived rank 110 may be rank 104 as it is perceived by a receiving user interface 106 or receiving user 107. Perceived rank 110 may be generated by message filter 108 based on a corresponding message rank 104 and filter rule 109. As will be described further, rank 104 may be increased or decreased for user interface 106 or receiving user 107 based on the configuration of a corresponding filter rule 109. Thus, where filter rules 109 differ between users 107, a different perceived rank 110 may be generated for each user 107 when message 101 is received by the users. In some aspects, perceived rank 110 may be the same as rank 104. In some aspects, perceived rank 110 may be determined in real-time, for example, when message 101 is provided for display at a receiving user's message stream. In other aspects, perceived rank 110 may be determined when message 101 is posted.

Message filter 108 may also generate a perceived rank 110 for message 101 based on rank 104 and a characteristic of one or more receiving users 107. In one aspect, the characteristic of the one or more receiving users 107 may include a social group assigned to the one or more receiving users by posting user 103. In this regard, posting user 103 may manage one or more social groups in the social network, each group including one or more contacts of posting user 103. Posting user 103 may designate that messages received from users in some social groups should have a higher importance than messages from users in other social groups. For example, perceived rank 110 may be generated by increasing or decreasing rank 104 by a value (for example, ±1) assigned by posting user 103 to the social group associated with receiving user 107.

In one example, system 100 may include a default rank for all messages. A posting user 103 may then assign a lower or higher rank 104 to posted messages 101. A receiving user 107 may configure message filter 108 to limit perceived rank 110 to a maximum (or minimum) rank. System 100 may then set perceived rank 110 in accordance with the limitation and provide message 101 for display at receiving interface 106 in accordance with the limited perceived rank.

The characteristic of a receiving user 107 may include a geographical distance between a location associated with receiving user 107 (for example, input at interface 106 by receiving user 107) and a location (for example, city, place, geographic region, or the like) associated with posting user 103 (for example, input at interface 102 by receiving user 103). The characteristic of the receiving user may also include a geographic region of the receiving user 107, wherein perceived rank 110 is higher when receiving user 107 is in a geographic region associated with posting user 103, and lower if the receiving user is in another geographic region. Likewise, filter rule 109 may be configured to set, for a message 101, a perceived rank 110 for each of one or more geographic regions. In this regard, the rank 104 of a message 101 may be increased or decreased based on a selected geographic region. Perceived rank 110 may be set to a higher value when receiving user 107 is in the same geographic region as a corresponding posting user 103, and a lower value if in another geographic region.

In another aspect, rank 104, or perceived rank 110, may be required to meet or exceed a rank threshold set at receiving interface 106 before the message may be viewable at a message stream of receiving interface 106. For example, a receiving user 107 may wish to display all messages 101 received from other users in his or her home state or city, while only displaying important messages 101 from other states and cities. In this regard, receiving interface 106 may be configured to lower the rank threshold for messages 101 received from the receiving user's home state or city, thereby allowing lower ranked messages from those locations to be displayed. Likewise, receiving interface 106 may be configured to raise the rank threshold for messages 101 received from other states and cities, thereby preventing lower ranked messages from the other states and cities to be displayed.

Rank 104 or perceived rank 110 may also be increased or decreased based on a distance between a stored location related to receiving user 107 and posting user 103. The further geographically receiving user 107 is from posting user 103, for example, the higher the rank the message may be required to have before it can be viewed by the receiving user. In this regard, a receiving user 107 may view more feeds (including lower level rankings) from users that are closer to the receiving user, while viewing less feeds from users further away.

Similarly, when a message 101 is posted at posting user interface 102, a variable message rank 104 may be selected to increase or decrease with respect to a receiving user's location. In this regard, a posting user 103 may, for example, configure distribution system 105 (for example, via posting interface 102) to automatically generate a perceived rank 110 having a higher ranking for messages viewed by other users in his or her home state or city, and having a lower ranking for messages viewed in other states and cities.

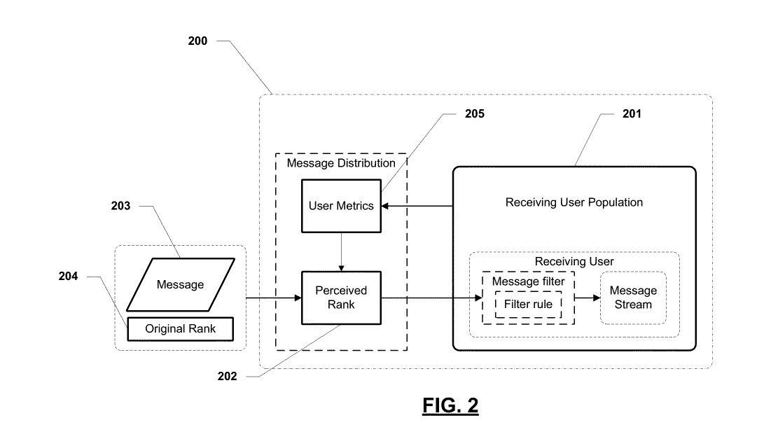

FIG. 2 is a diagram of an example system 200 for adjusting a message rank based on a receiving user population 201 according to one aspect of the subject technology. In one aspect, a perceived rank 202 may be generated for a message 203 based on an original rank 204 of message 203 and one or more user metrics 205. System 200 may collect user metrics 205 from user population 201, including how the message, similar messages, or messages from the same posting user, was treated by a user in user population 201. User population 201 may include all users who have access to or who can view a posting user's messages, all contacts of the posting user, a subcategory of those contacts (for example, “friends”, “family”, “acquaintances”), or the like. In some aspects, system 200 may use metrics 205 to automatically adjust a previously determined perceived ranking of a message (for example, as determined by a message filter 108 or filter rule 109).

In some aspects, if over a predetermined number of a posting user's contacts have lowered the rank originally assigned by the posting user then system 200 may determine that the perceived rank for all messages posted by the same user may also be decremented (for example, from “high importance” to “medium importance”). In one example, a receiving user may indicate that all of a posting user's important messages should be not given any extra weight (for example, limited to a default level). If more than a predetermined number of contacts have similarly restricted messages from the same posting user then system 200 may limit the perceived rank of messages from the posting user to the remaining contacts.

System 200 may also determine or adjust the perceived rank of a message based on the overall response to the message (for example, user population 201). For example, if a message receives a large amount of replies in a short period of time then the system may increase the perceived ranking of the message. System 200 may compare the overall response to the rank given to the message by a posting user. For example, if a high rank (for example, above a default rank) is given to a message that states, for example, “I graduated college,” and a large amount of users endorse, share, or respond to the message post (for example, with a “congratulations”), or the like, then system 200 may determine that the rank is appropriate. Alternatively, if, after a predetermined amount of time, a message received none or very little response then system 200 may decrease the perceived ranking of the message or set it to a default level.

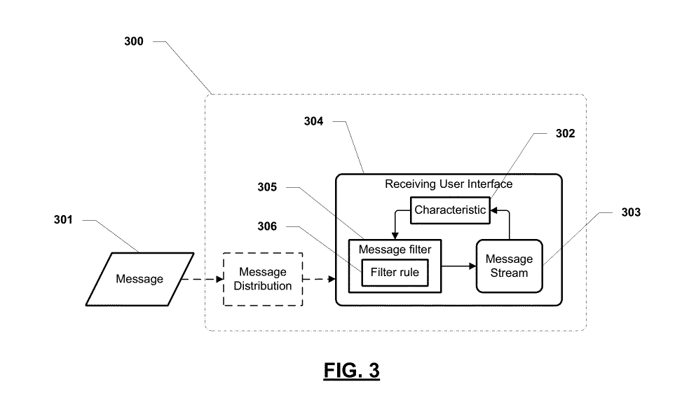

FIG. 3 is a diagram of an example system 300 for automatically filtering a message 301 based on one or more characteristics 302 of a message stream 303 according to one aspect of the subject technology. As described previously, a receiving user interface 304 may filter certain messages 301 according to selections made by a receiving user. A characteristic 302 of message stream 303 may include how an individual message or a group of messages, or messages from a particular user are treated (for example, discarded, ignored, ranked at a lower level, or the like). For example, characteristic 302 may be determined by a user selecting to view all messages from a certain user as “low importance,” or by the user decrementing or incrementing the importance level of all messages for one or more selected users or geographical regions. In some aspects, characteristic 302 may update a message filter 305, to change how a message 301 may be viewed, by adjusting one or more settings of a filter rule 306. For example, even though a message 302 from a particular user may be designated as “important,” filter rule 306 may be adjusted to not treat that message the same.

Another characteristic 302 of message stream 303 may include a receiving user's interaction with received messages 301 in a message stream 303. For example, system 300 may determine that the receiving user has stopped, or dramatically reduced, interacting with (for example, reading or responding to) one or more message streams 303, with messages from one or more particular users, or with all messages generally. To make this determination, system 300 may compare the number of interactions over a predetermined period (for example, a week or month) with, for example, a number of new contacts added in the same predetermined period. In response, system 300 may lower the perceived rank of the message, or increase the ranking threshold required to display a message to a user. To this end, the number of viewable messages 301 in the user's message stream 303 may be reduced as the user's interaction with message stream 303 is reduced (for example, over a predetermined period of time). System 300 may then automatically scale back limits placed on the messages as the user interacts more with the viewed messages (for example, over the predetermined period of time) by increasing the perceived rank of messages 301. In one example, the limits may be scaled back incrementally, for example, by increasing the number of viewable messages 301 by a number proportionate to an increase in interactions.

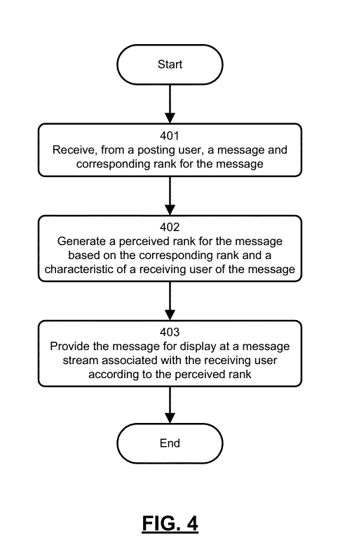

FIG. 4 is a flowchart illustrating an example process for filtering messages in a social network according to one aspect of the subject technology. According to one aspect, a social network (including, for example, system 100, 200 or 300) may be configured to send and receive messages through one or more message streams. At 401, a message and a corresponding rank for the message are received in the social network from a posting user. In one aspect, the message may be posted to a general message stream for display to the posting user's contacts. At 402, a perceived rank is generated for the message based on the corresponding rank and a characteristic of a receiving user of the message. The perceived rank may be an individualized message ranking, with a different ranking set for each user, or, in other aspects, the perceived rank may be a generalized message ranking, with the same ranking set for each user. In some aspects, the perceived rank may also be according to a filter rule. The filter rule, may, for example, be a rule set by the posting user, a receiving user, or automatically generated based on one or more metrics collected from a group of users. At 403, the message is provided for display at a message stream associated with the receiving user according to the perceived rank.

FIG. 5 is a diagram of an example system 500 for filtering and displaying messages in a social network according to one aspect of the subject technology. System 500 may include one or more servers 501 configured to host a social network to one or more computing devices over a network 502. A first computing device 503 (for example, a desktop or server computer, tablet or notebook computer, PDA, smart phone, a television or other display device with one or more location-aware computing devices embedded therein or attached thereto, or the like) may display a first user interface 504 (for example, a web browser or thin client) to a first user 505. First user interface 504 may include a message posting interface 506 (for example, a website hosted by servers 501) for posting messages to the social network for viewing by other users. Messages received at posting interface 506 may be stored by the one or more servers 501 in a database 507 configured for storing social network information (for example, messages and message streams). A second computing device 508 may display a second user interface 509 to a second user 510. Second user interface 509 may include a message receiving interface 511 for receiving and viewing messages posted to the social network (for example, stored in database 507). Message receiving interface 511 may include a message stream 512 and one or more filter controls 513 (for example, a drop down menu, radio button menu, input text box, or the like) for filtering messages displayed in message stream 512.

In one aspect, system 500 (for example, servers 501 or computing device 503 or 508) may receive a message and a rank associated with the message at posting user interface 506 from first user 505. For each of a plurality of user contacts (for example, designated by user 505), system 500 may determine a perceived rank associated with the message based on the rank and a filter rule. The message may then be provided for display to one or more of the plurality of user contacts according to the perceived rank by servers 501 and database 507. Message receiving interface 511 may be configured by second user 510 (for example, using control 513) to reduce the display of lesser important messages using filter controls 513.

In other aspects, the display of received messages may be changed based on their associated ranks. For example, a message having a rank (for example, a perceived rank) above a predetermined threshold (for example, predetermined by the system or set at receiving interface 511) may be highlighted in a different color (for example, red), displayed using a different font or typeface (for example, bold or underline), or the like, to distinguish the message from other (for example, lesser important) messages. In some aspects, user interface 511 may be configured to facilitate displaying a received message with a rank above the predetermined threshold at a different location on user interface 511. For example, the message may be displayed outside message stream 512, in a different message stream or window, displayed as a hover graphic, pop-up graphic, or the like.

In another aspect, system 500 may provide one or more messages for display at a message stream 512 of a message receiving interface 511. Each message may include the previously described corresponding message rank. For each of the one or more messages, system 500 may determine a perceived rank based on the corresponding message rank and a filter rule. In one aspect, the filter rule may be set by options selected at filter control 513. System 500 may then filter the one or more messages for display at message stream 512 based on one or more respective perceived ranks. In this regard, each perceived rank may be determined by a function of the corresponding message rank and a filter rule.

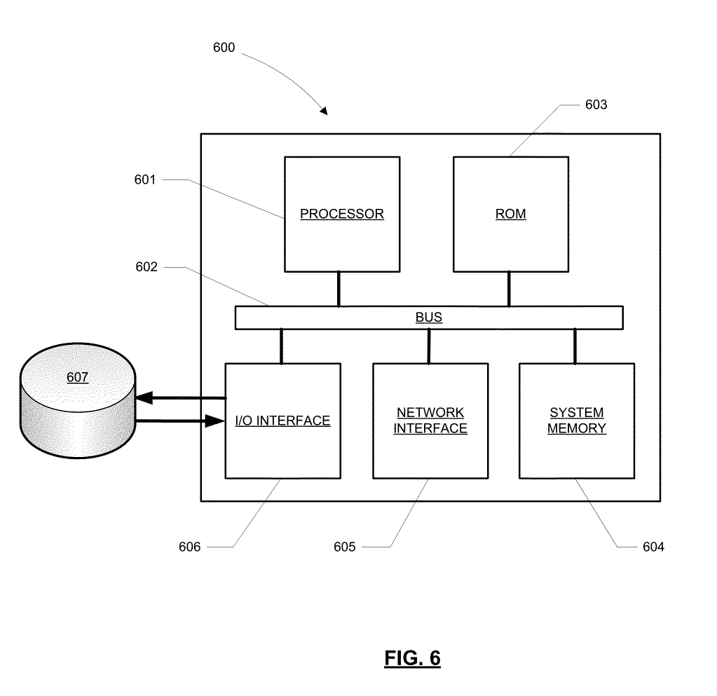

FIG. 6 is a diagram illustrating an example machine or computer for filtering and displaying messages in a social network, including a processor and other internal components, according to one aspect of the subject technology. In some aspects, a computing device 600 (for example, computing device 503 or 508, server 501, or the like) includes several internal components such as a processor 601, a system bus 602, read-only memory 603, system memory 604, network interface 605, I/O interface 606, and the like. In one aspect, processor 601 may also be communication with a storage medium 607 (for example, a hard drive, database, or data cloud) via I/O interface 606. In some aspects, all of these elements of device 600 may be integrated into a single device. In other aspects, these elements may be configured as separate components.

Processor 601 may be configured to execute code or instructions to perform the operations and functionality described herein, manage request flow and address mappings, and to perform calculations and generate commands. Processor 601 is configured to monitor and control the operation of the components in server 600. The processor may be a general-purpose microprocessor, a microcontroller, a digital signal processor (DSP), an application specific integrated circuit (ASIC), a field programmable gate array (FPGA), a programmable logic device (PLD), a controller, a state machine, gated logic, discrete hardware components, or a combination of the foregoing. One or more sequences of instructions may be stored as firmware on a ROM within processor 601. Likewise, one or more sequences of instructions may be software stored and read from system memory 605, ROM 603, or received from a storage medium 607 (for example, via I/O interface 606). ROM 603, system memory 605, and storage medium 607 represent examples of machine or computer readable media on which instructions/code may be executable by processor 601. Machine or computer readable media may generally refer to any medium or media used to provide instructions to processor 601, including both volatile media, such as dynamic memory used for system memory 604 or for buffers within processor 601, and non-volatile media, such as electronic media, optical media, and magnetic media.

In some aspects, processor 601 is configured to communicate with one or more external devices (for example, via I/O interface 606). Processor 601 is further configured to read data stored in system memory 604 and/or storage medium 607 and to transfer the read data to the one or more external devices in response to a request from the one or more external devices. The read data may include one or more web pages and/or other software presentation to be rendered on the one or more external devices. The one or more external devices may include a computing system such as a personal computer, a server, a workstation, a laptop computer, PDA, smart phone, and the like.

In some aspects, system memory 604 represents volatile memory used to temporarily store data and information used to manage device 600. According to one aspect of the subject technology, system memory 604 is random access memory (RAM) such as double data rate (DDR) RAM. Other types of RAM also may be used to implement system memory 604. Memory 604 may be implemented using a single RAM module or multiple RAM modules. While system memory 604 is depicted as being part of device 600, those skilled in the art will recognize that system memory 604 may be separate from device 600 without departing from the scope of the subject technology. Alternatively, system memory 604 may be a non-volatile memory such as a magnetic disk, flash memory, peripheral SSD, and the like.

I/O interface 606 may be configured to be coupled to one or more external devices, to receive data from the one or more external devices and to send data to the one or more external devices. I/O interface 606 may include both electrical and physical connections for operably coupling I/O interface 606 to processor 601, for example, via the bus 602. I/O interface 606 is configured to communicate data, addresses, and control signals between the internal components attached to bus 602 (for example, processor 601) and one or more external devices (for example, a hard drive). I/O interface 606 may be configured to implement a standard interface, such as Serial-Attached SCSI (SAS), Fiber Channel interface, PCI Express (PCIe), SATA, USB, and the like. I/O interface 606 may be configured to implement only one interface. Alternatively, I/O interface 606 may be configured to implement multiple interfaces, which are individually selectable using a configuration parameter selected by a user or programmed at the time of assembly. I/O interface 606 may include one or more buffers for buffering transmissions between one or more external devices and bus 602 and/or the internal devices operably attached thereto.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that the specific order or hierarchy of steps in the processes disclosed is an illustration of example approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

The previous description is provided to enable any person skilled in the art to practice the various aspects described herein. The previous description provides various examples of the subject technology, and the subject technology is not limited to these examples. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the invention.

The term website, as used herein, may include any aspect of a website, including one or more web pages, one or more servers used to host or store web related content, and the like. Accordingly, the term website may be used interchangeably with the terms web page and server. The predicate words “configured to”, “operable to”, and “programmed to” do not imply any particular tangible or intangible modification of a subject, but, rather, are intended to be used interchangeably. For example, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an “embodiment” may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a “configuration” may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

1. A computer-implemented method, comprising:
receiving, from a posting user via an electronic network, a message together with a corresponding user-provided rank for the message;
identifying a characteristic of a receiving user designated to receive the message, the receiving user being different than the posting user;
determining that a predetermined number of user contacts of the posting user adjusted a ranking for one or more messages provided by the posting user;
adjusting the corresponding user-provided rank based on a function of the identified characteristic of the receiving user and the adjusted ranking of the user contacts to generate a perceived rank for the message; and
providing, via the electronic network, the message for display at a message stream associated with the receiving user according to the perceived rank.

2. The computer-implemented method of claim 1, wherein the characteristic of the receiving user includes a geographical distance between a location associated with the receiving user and a location associated with the posting user.

3. The computer-implemented method of claim 1, wherein the characteristic of the receiving user is a geographic region of the receiving user, wherein the perceived rank is higher when the receiving user is in a geographic region associated with the posting user, and lower if the receiving user is in another geographic region.

4. The computer-implemented method of claim 1, wherein the characteristic of the receiving user includes a social group assigned to the receiving user by the posting user.

5. The computer-implemented method of claim 1, wherein the perceived rank is based on how the message is treated by a group of receiving users.

6. The computer-implemented method of claim 1, wherein the characteristic of the receiving user includes how other messages from the posting user have been treated by the receiving user.

7. The computer-implemented method of claim 1, wherein the characteristic of the receiving user includes a number of interactions with the message stream by the receiving user over a predetermined period of time.

8. The computer-implemented method of claim 7, further comprising:
reducing the perceived rank when the number of interactions over the predetermined period of time is below a predetermined threshold; and
increasing the perceived rank as the number of interactions with the message stream increases.

9. A non-transitory machine-readable medium including machine-executable instructions for performing a method comprising:
facilitating the receipt at one or more computing devices of one or more messages posted by a user for display in a message stream of an online social network accessible through an electronic network, a message posted by the user including a corresponding message rank provided by the user;
determining that a predetermined number of user contacts of the user adjusted a ranking for the one or more messages;
for a respective message, determining a perceived rank for the message based on the corresponding message rank and geographical region of one or more receiving users of the respective message and the adjusted ranking of the user contacts;
filtering the one or more messages for display in the message stream to the one or more receiving users based on respective perceived ranks; and
providing, via the electronic network, one or more of the filtered messages to the message stream for display according to the respective perceived ranks.

10. The machine-readable medium of claim 9, wherein determining the perceived rank includes adjusting the message rank according to a geographical distance between a stored location related to the message stream and a corresponding posting user.

11. The machine-readable medium of claim 9, wherein determining the perceived rank includes increasing the perceived rank for receiving users associated with the same geographic region as a corresponding posting user, and lowering the perceived rank for receiving users associated with other geographic regions.

12. A system, comprising:
a processor; and
a memory, the memory including instructions that, when executed, cause the processor to:
facilitate receiving, from a posting user interface via an electronic network, a message together with a user-provided message rank for the message;
determine that a predetermined number of social network contacts of a sender of the message adjusted a ranking for one or more messages provided by the sender of the message;
for each of a plurality of user contacts designated by the message, determine a respective characteristic of the user contact, and adjust the message rank based on the respective characteristic and the adjusted ranking of the social network contacts to generate a respective perceived rank for the user contact; and
provide, via the electronic network, the message for display to one or more of the plurality of user contacts according to each respective perceived rank determined for the one or more of the plurality of user contacts.

13. The system of claim 12, wherein the characteristic of the respective user contact includes one or more adjustments to the message rank received from the posting user interface.

14. The system of claim 12, wherein the characteristic of the respective user contact includes one or more interactions with other messages at the message stream of the respective user contact.

15. The system of claim 14, wherein the instructions, when executed, further cause the processor to:
reduce the perceived rank for the message when a number of the interactions over a predetermined period of time is below a predetermined threshold; and
increase the perceived rank as the number of the interactions increases.

16. The system of claim 15, wherein the perceived rank for the message is based on the number of the interactions compared to a number of new user contacts added by the respective user contact in the predetermined period.

17. The system of claim 12, wherein the message is provided to be displayed at location of a user interface, or in a color, selected based on the perceived rank.

18. The system of claim 12, wherein the instructions, when executed, further cause the processor to:
generate the characteristic of the respective user contact based on selections received from the posting user interface.

19. The system of claim 18, wherein the characteristic of the respective user contact includes a geographical distance between a location associated with a posting user and a location associated with the respective user contact.

20. The system of claim 19, wherein determining the perceived rank includes setting the perceived rank at a higher level for user contacts that are closer to the posting user than for user contacts that are farther away from the posting user.

21. The system of claim 12, wherein the characteristic of the respective user contact includes a geographic region of the respective user contact.

22. The system of claim 21, wherein determining the perceived rank includes setting the perceived rank at a higher level for user contacts associated with the same geographic region as the posting user, and a lower level for user contacts in other geographic regions.

23. The system of claim 12, wherein the instructions, when executed, further cause the processor to:
for the plurality of user contacts, determine the respective perceived ranks based on one or more metrics of a receiving user population, wherein the receiving user population includes the plurality of user contacts.

24. The system of claim 23, wherein the one or more metrics include an overall user response to the message.

25. The system of claim 12, wherein the instructions, when executed, further cause the processor to:
automatically adjust a perceived rank for a first set of the plurality of user contacts based on filtering adjustments made by a second set of the plurality of user contacts.
